(19) United States
(12) Patent Application Publication
(10) Pub. No.: US 2004/0139410 A1
(43) Pub. Date: Jul. 15, 2004

(54) Method for developing an electronic component

(75) Inventors: Majid Ghameshlu, Wien (AT); Karlheinz Krause, Planegg (DE); Herbert Taucher, Modling (AT)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 10/654,604

(22) Filed: Sep. 4, 2003

(30) Foreign Application Priority Data
Sep. 5, 2002 (DE) 02019999.8

(51) Int. Cl. G06F 17/50

(52) U.S. Cl. 716/6; 716/5

(57) ABSTRACT

With methods for developing an electronic component, in which a layout is executed for a component and a file is also generated with timing information, the present invention avoids the superfluous net list changes by providing the following steps: a) Executing an initial timing analysis using the file to identify violations of timing requirements; b) Producing the chip in accordance with the current layout, if no timing violations were detected, otherwise c) Saving information about violations of the timing requirements identified in at least one patch list; d) Changing the file in accordance with the violation information in the patch list; e) Executing the timing analysis again using the modified file; f) Iteration of Steps c), d) and e), if a new timing violation was established; g) When no more timing violations are established, executing a layout adaptation step and generating a new file containing runtime information based on the adapted layout; and h) Returning to Step a) and executing the step.

The invention relates to electronic components, in particular to a method of developing or creating a design of an electronic component in which a layout for a component is executed and also a file with timing information is generated.

Electrical components are frequently embodied as Application Specific Integrated Circuits (ASICs). ASICs designate an arrangement of logical gates as well as memory circuits and their connection on an individual Silicon wafer. ASICs are a collection of circuits with simple functions, such as flip flops, inverters, NANDs and NORs as well as of more complex structures, such as memory arrangements, adders, counters and phase locked loops. The various circuits are combined in an ASIC to execute a specific purpose or application. ASICs are used in numerous products. e.g. consumer products such as video games, digital cameras, in vehicles and PCs, as well as in high-end technology products such as workstations and routers.

An application-specific IC or ASIC is generally developed in five consecutive phases: Specification, coding, synthesis, layout and production. For a precise overview of the individual phases please refer to the standard works on the subject such as Tietze, Schenk, “Halbleiterschaltungstechnik”, 9. Auflage, (semiconductor circuit technology, 9th edition) Springer-Verlag, Berlin, 1989 and Nigel Horspool, “The ASIC Handbook”, 2001, Prentice Hall PTR. Only the final phase of an ASIC design will be described in this document, especially the layout phase and possible modification of the layout on the basis of timing verification.

In this end phase, which is referred to in technical circles as “timing closure”, a number of corrections, including the ASIC layout are generally necessary as a result of timing violations. In such cases the number of modifications increases with the complexity of the operating frequency and the deep submicron effects. The changes required as a result of timing violations are derived from the timing reports from a Static Timing Analysis (STA). The more the technology is refined, i.e. the limits of the operating frequency are approached, the higher is the number of corrections that are needed. With a current ASIC design with critical timing requirements several thousand timing corrections can be necessary for example.

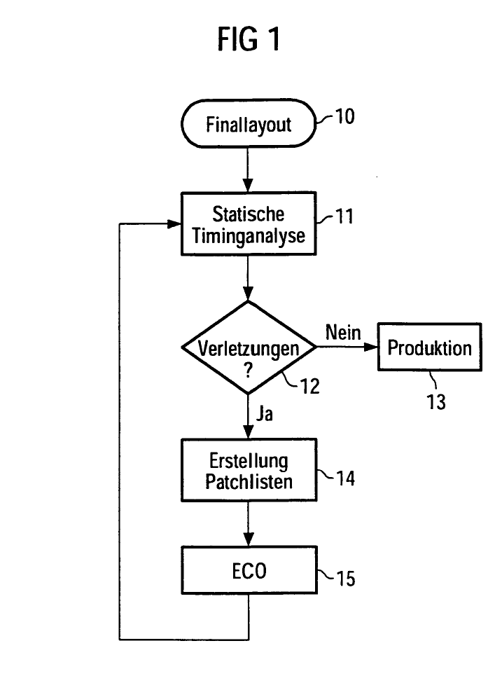

An example: of a conventional sequence of timing closure is shown in FIG. 1. In Step 10, after the first three ASIC design phases have been executed, the net lists generated in the previous phases, i.e. lists with components and their connections are placed on a chip surface and wired. In this case the previously defined layout constraints or restrictions must be adhered to. Subsequently in Step 11 a timing analysis, specifically a static timing analysis, is executed and timing reports are generated which are then investigated in a subsequent checking step 12 with regard to timing violations. Should no timing violations be identified, production of the ASIC can be started in accordance with the net lists generated in the last layout. If however timing violations were identified in Step 12, what are known as patch lists are then generated instead in Step 14 which record the type and scope of the required timing corrections, based on the timing violations previously detected. Subsequently in Step 15 a layout merge is executed, which is also designated as an Engineering Change Order (ECO). In ECO Step 15 the physical correction measures shown in the patch lists as a result of timing violations are implemented in the layout. Since however the correction measures can have undesired side effects, the procedure returns to Step 11 and a new static timing analysis is executed. The procedural sequence now repeats itself until all timing violations are rectified.

The problem that arises is that the effectiveness of correction measures as well as their success and any undesired side effects are only apparent after implementation in the layout, i.e. after the time-consuming Step 15, and execution of a new static timing analysis.

The present invention addresses the problem of creating a procedure for the development of an electronic module in which a disproportionate change to the net lists is avoided for the layout and thereby enabling the entire ASIC design process to be shortened.

This object is achieved by a method for developing an electronic component in accordance with the precharacterizing clause, featuring the following steps:

a) Execution of an initial timing analysis using the file to identify violations of the timing requirements;

b) Producing the chip in accordance with the current layout, if no timing violations were detected, otherwise

c) Saving information about violations of the timing requirements detected in at least one patch list;

d) Changing the file in accordance with the violation information in the patch list;

e) Executing the timing analysis again using the modified file;

f) Iteration of Steps c), d) and e), if a new timing violation was established;

g) When no more timing violations are established, executing a layout adaptation step and generating a new file containing runtime information based in the adapted layout;

h) Returning to Step a) and executing the step.

The method in accordance with the invention produces the following benefits:

No expensive layout net list changes to analyze;

Completeness check possible, (i.e. a check as to whether all timing violations are covered by the measures);

Risk avoidance in the layout adaptation step, in particular during ECO;

Cost reduction from savings in processing time;

Speeding up the time-to-market.

In accordance with a further aspect, the violation information features information about physical measures that must be implemented in the layout to avoid the timing violations. In Step d) of changing the file interventions are now made in this file which are equivalent to the physical measures defined by the violation information in the patch lists and conform to the file format of this file.

This incorporates net list-equivalent modifications at the required points in the file without having to access a new layout.

In accordance with a particularly advantageous form of embodiment the file is a Standard Delay Format (SDF) file. In this way the method is based on an existing database, namely the SDF file, and allows a new timing analysis without a new layout.

In accordance with a further particularly advantageous form of embodiment Step a) is a Static Timing Analysis (STA). This allows a pre-analysis to be performed to obtain a rapid evaluation of the modifications performed.

In accordance with another advantageous form of embodiment a new patch list is created each time Step c) is run, in which violation information is stored to allow individual modification steps to be easily discarded or modified, should pre-analysis show that a modification has not produced the desired result.

In accordance with a further advantageous form of embodiment a patch list is created at the beginning of the procedure when Step c) is first run and on each further execution of Step c) further violation information obtained is appended to the existing patch list. This means that all the necessary modifications are stored and administered centrally.

In accordance with an alternate advantageous form of embodiment scripts and tools are used that both automatically generate the patch lists and also automatically execute the changes to the SDF file. This significantly reduces the timing and cost effort for timing closure since all steps can be performed with computer support.

An exemplary embodiment of the invention is shown in the diagrams and is described in more detail below. The diagrams show:

FIG. 1 a previously described conventional method for constructing an electronic component;

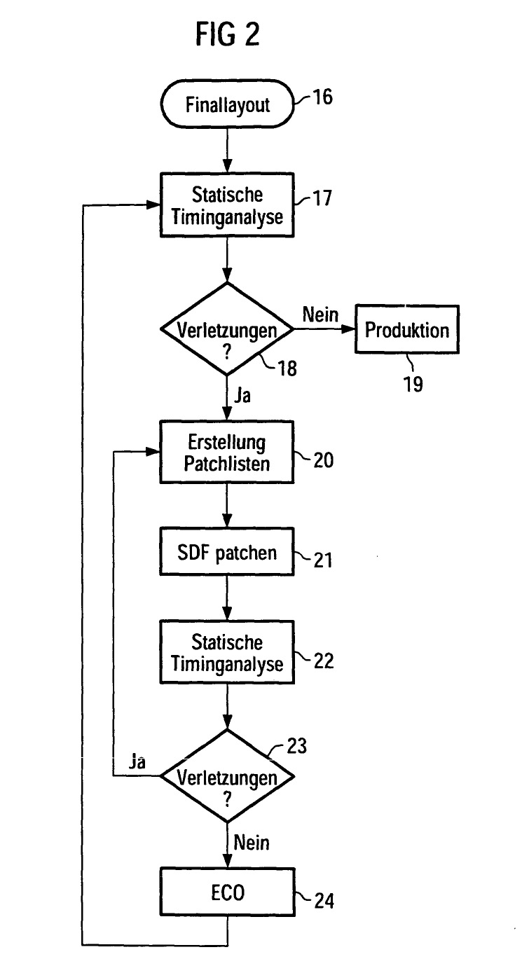

FIG. 2 a flowchart for construction of an electronic component in accordance with the present invention.

With reference to FIG. 2 the preferred procedure for construction of an electronic component in accordance with the present invention will now be described. In particular a method will be presented to reduce the total test time required on timing closure of an ASIC to cover and rectify timing violations. The procedure begins in Step 16 with the execution of the final layout. With the ASIC layout the net lists obtained from the preceding ASIC design steps (Specification, Coding and Synthesis) are placed on the chip surface and routed. This is referred to in technical circles as place and route.

Within the context of the layout process a file with timing information is also generated to check the timing behavior of the circuit. In the preferred exemplary embodiment this file is what is known as an SDF(Standard Delay Format) file. The SDF file contains data such as the entire timing for all paths in the ASIC. Here the real timing behavior of the circuit is calculated from the geometric data of the layout on the basis of many factors, such as for example the output driver strengths of the individual components, the relevant number of inputs of other components connected and the length of the relevant connection and is stored in the SDF file. Content and specification of an SDF file are sufficiently well known in technical circles and are described for example in the document entitled “Standard Delay Format Specification”, Version 3.0, May 1995, published by Open Verilog.

The method in accordance with the invention continues after the final layout with a timing analysis in Step 17. In the preferred exemplary embodiment the timing analysis is a Static Timing Analysis (STA). The timing analysis is based on the previously generated SDF file which contains all timing values and all paths needed to execute the timing analysis. The STA connects all paths that are relevant for observing a complete path. The STA also sorts and combines the paths for a timing observation and outputs what are known as timing reports.

In the subsequent procedural step 18 the timing reports created in the STA are investigated for timing violations. Timing violations are generally subdivided into what are known as hold and setup violations. The setup time is the period of time before the rising edge of the synchronization timing. The hold time is the period of time after the rising edge of the synchronization timing. When the setup and hold time criteria were not fulfilled for a flip-flop for example, this leads to a timing violation and the output of the flip-flop is not securely guaranteed

Should no timing violation steps be identified in Step 18 the Timing Closure Phase of the ASIC designs can be concluded and the corresponding net lists generated from the last layout will be used for ASIC production (Step 19).

If however timing violations were identified in Step 18, the process continues with Step 20. In Step 20 what is known as the patch list is created in which the locations in the ASIC are listed where intervention is necessary to correct the timing violations. The patch lists also include in the preferred exemplary embodiment information about physical measures that must be performed to rectify the timing violations. These measures are dealt with in detail below.

In the next Step 21 the required changes and corrections shown in the patch list are incorporated directly into the SDF file.

This involves including the net list-equivalent modifications at the required points in the SDF file without changing the net list for the layout at this time.

The adapted SDF file as regards corrections is now used in Step 22 for a new static timing analysis. This preliminary STA lets you see whether the measures taken have dealt with the timing violations previously revealed, whether the measures cover all violations (completeness) and whether the corrections result in undesired side effects.

Thus in Step 23 the timing reports delivered by STA 22 are checked again for violations. If Step 23 reveals that there are still timing violations present, the procedure returns to Step 20 and Steps 20, 21, 22 and 23 are subsequently repeated as often as necessary until no more timing violations occur.

When it is established in Step 23 that there are no more timing violations the procedure continues with Step 24 In Step 24 what is known as a layout merge of Engineering Change Order (ECO) is performed. In ECO 24 the net lists are modified in accordance with the current patch list or lists. After changing the net list for the layout the procedure goes to Step 17, back to the initial timing analysis of Step 17. The procedure sequence then proceeds again as described above. This means that at least Steps 17, 18, and where necessary also Steps 20, 21, 22, 23, 24 are repeated.

Thus, based on an existing database, namely the SDF file, net list-equivalent modifications can be made at the required points in the SDF file to enable a preliminary analysis to be conducted, and enable this to be done without having to access a new layout. The net list for the layout thus does not have to be changed initially.

As already mentioned above timing violations can generally be divided into hold and setup violations. If such violations are identified in Step 18 and FIG. 2, the following physical measures can be taken:

a) Hold violation: Replacement of the flip-flop, e.g. extended hold flip-flop (FF), insertion of delay elements, a placing of buffer before the violated inputs.

b) Setup violations: So-called delayed clock measure: The clock in the destination FF is delayed and the TI input of the FF is delayed.

So-called early clock measure: The clock at the start FF is made more quickly (insertion of the corresponding delay element before the TI input of the subsequent FF in the SCAN chain still has to be entered into the patch list manually).

Upsizing of gates: These are entered manually into the patch list and taken into consideration at the next stage (SDF patch or change SDF).

For these physical measures there is provision within the framework of the present invention for equivalent SDF file modifications in accordance with the table below and if nec. in Step 21:

| Physical measure | Equivalent int rvention in SDF file |
|---|---|
| Hold violation: Insertion of delay | Patch or correct hold/setup |
| element(s) | of destination FF |
| Setup violation: Delayed clock, delay | Patch interconnect of destination |
| element at TI input | FF/CP, patch hold/setup of |
| | destination FF/TI |
| Setup violation: Early clock, | Patch interconnect of destination |
| Delay element at TI input of the | FF/CP, patch hold/setup |
| subsequent flip-flop (FF) | of subsequent FF/TI |
| Insertion or removal of delay | Patch IOPATH |
| elements, buffers, . . . | |

It should further be pointed out that in accordance with the method in the preferred exemplary embodiment a new patch list in which violation information is stored is created each time Step 20 is run.

In accordance with other exemplary embodiments however only one patch list is administered during the timing closure. In this case, on the first pass through Step 20 a patch list is created and for each further pass of the step c) additionally obtained violation information is appended to the existing patch list.

In accordance with an advantageous exemplary embodiment the required SDF file modifications can also be automated. For the execution of the method in accordance with the invention scripts and tools can be used which automatically execute both the patch list and the changes: to the SDF file.

1. Method for developing an electronic component, whereby a layout is executed for the component (16) as well as a file with timing information generated, characterized by the following steps,
a) Executing (17) an initial timing analysis using the file to identify violations of timing requirements;
b) Producing (19) the component in accordance with the current layout if no timing violation was established (18), otherwise
c) Saving (20) information about timing requirement violations identified in at least one patch list;
d) Modifying (21) the file according to the violation information in the patch list;
e) New execution (22) of the timing analysis using the modified file;
f) iterative repetition (23) of steps c), d) and e), if a new timing violation was identified;
g) When no more timing violations are established, executing a layout adaptation step and generating a new file containing runtime information based in the adapted layout; and
h) Return to Step a) (17) and executing the step.

2. Procedure according to claim 1, characterized in that physical measures that must be implemented in the layout are derived from the violation information to avoid the timing violations.

3. Procedure according to claim 1, characterized in that, in the step of changing the file in accordance with Step d) (21) interventions are made into this file which are equivalent to the physical measures defined by the violation information in the patch list and conform with the file format of this file.

4. Procedure in accordance with claim 1, characterized in that the file is a file in Standard Delay Format (SDF).

5. Procedure in accordance with claim 1, characterized in that Step e) (22) is a static timing analysis (STA).

6. Procedure in accordance with claim 1, characterized in that the layout adaptation step g) (24) includes an Engineering-Change-Order-(ECO) step.

7. Procedure in accordance with claim 1, characterized in that with each pass of Step c) (20) a new patch list is created in which violation information is stored.

8. Procedure in accordance with claim 1, characterized in that at the beginning of the first procedure during the first pass of Step c) (20) a new patch list is created and with each new pass of Step c) (20) further violation information obtained is appended to the existing patch list.

9. Procedure in accordance with claim 1, characterized in that in the layout adaptation step (24) the violation information is used from the patch list(s) to modify net lists for the layout.

10. Procedure in accordance with claim 1, characterized in that scripts and tools are used which automatically perform both patch list generation (20) and also make the changes: (21) to the SDF file.
